(19) United States
(12) Patent Application Publication
(10) Pub. No.: US 2013/0272777 A1
(43) Pub. Date: Oct. 17, 2013

(54) FRAME CONNECTION

(71) Applicants: Darren Hayter, Trigg (AU); Edward Joseph Khoury, Bateman (AU)

(72) Inventors: Darren Hayter, Trigg (AU); Edward Joseph Khoury, Bateman (AU)

(21) Appl. No.: 13/993,067

(22) PCT Filed: Dec. 9, 2011
(86) PCT No.: PCT/AU2011/001591

§ 371 Date: Jun. 10, 2013

(30) Foreign Application Priority Data
Dec. 10, 2010 (AU) 2010905422
Jan. 7, 2011 (AU) 201190045

(51) Int. Cl. F16B 7/00

(52) U.S. Cl. CPC F16B 7/00
USPC 403/205; 403/292

(57) ABSTRACT

Described is a frame connection for connecting members of a frame without visible fixings. The frame connection comprises first and second elongate members, each having first and second channels. First and second connection members are provided, each having a first end portion comprising a first planar member and a second end portion comprising a second planar member. The end portions each include one or more holes therein. The first end portions of the first and second connection members are received in the first and second channels, respectively, of the first elongate member, and the second end portions are received in the first and second channels, respectively, of the second elongate member. Fasteners are received through the holes to secure the first and second connection members to the first and second elongate members and side cover members are then secured across the first and second channels.

### BACKGROUND OF THE INVENTION

(1) Field of Invention

The present invention relates to a frame connection and, more particularly, to a frame connection for connecting members of a frame without visible fixings.

(2) Description of Related Art

Many structures such as fence panels, screening panels, balustrades, and railings comprise an external frame supporting a plurality of cross members. The members forming the frame generally comprise extrusions that are cut at 45 degrees at the ends and secured to form the frame.

A common method of joining the ends of the extrusions is to insert a single angle piece into the end of each of the extrusions and screw through the sides of the extrusions into the angle piece to hold the extrusions together. While such an arrangement is relatively simple to assemble, the corner connection can tend to become loose due to flexing of the extrusions in use, Further, this arrangement can result in visible fixings, which detracts from the appearance of the frame.

Thus, a continuing need exists for a frame connection for connecting members of a frame that provides simple assembly and a secure connection, without visible fixings.

### SUMMARY OF THE INVENTION

The present invention relates to a frame connection and, more particularly, to a frame connection for connecting members of a frame without visible fixings. The frame connection comprises a first elongate member having first and second channels, the first channel being in a first longitudinal side of the first elongate member and the second channel being in an opposed second longitudinal side of the first elongate member. The frame connection also comprises a second elongate member having first and second channels, the first channel being in a first longitudinal side of the second elongate member and the second channel being in an opposed second longitudinal side of the second elongate member. Further, the frame connection comprises a first connection member having a first end portion comprising a first planar member and a second end portion comprising a second planar member, each of the first and second end portions including one or more holes therein. Additionally, the frame connection comprises a second connection member having a first end portion comprising a first planar member and a second end portion comprising a second planar member, each of the first and second end portions including one or more holes therein The frame connection also comprises side cover members. Moreover, the first end portions of the first and second connection members are received in the first and second channels, respectively, of the first elongate member, the second end portions of the first and second connection members are received in the first and second channels, respectively, of the second elongate member, fasteners are received through the holes to secure the first and second connection members to the first and second elongate members, and the side cover members are then secured across the first and second channels of the first and second elongate members.

In another aspect, the first and second end portions of the first and second connection members each comprise opposed parallel sides and a distal end

In another aspect, the opposed parallel sides of each of the first and second end portions are provided with a plurality of protrusions thereon to engage with the inner sides of the channels such that the connection members are press fit into the channels.

In another aspect, the protrusions are constructed of a material to be deformed as the protrusions engage with inner sides of the channels.

In another aspect, the protrusions each comprise a triangular shaped protrusion.

In another aspect, the first and second elongate members are formed by parallel first and second end walls interconnected by first and second inner walls, such that the first channel is defined adjacent a first side of the elongate member between the first inner wall and the first ends of the first and second end walls and the second channel is defined adjacent a second side of the elongate member between the second inner wall and the second ends of the first and second end walls.

In another aspect, the first and second channels of the elongate members are of complementary shape to the first and second end portions of the connection members such that in cross section the length of the channels between the first and second end wails is relatively large compared to the width.

In another aspect, each of the first and second side walls is provided with longitudinal slots along the edges thereof such that the slots can receive complementary ribs provided on the side cover members to allow the side cover members to be press fit across the channels.

In another aspect, the first and second planar members are oriented in the same plane and opposed parallel sides of the first planar member are perpendicular to opposed parallel sides of the second planar member.

In another aspect, the first planar member of each connection member is oriented in a plane perpendicular to that of the second planar member,

In another aspect, a connection body is provided such that the connection body connects a portion of the first connection member between the first and second ends thereof to the second connection member between the first and second ends thereof.

In another aspect, the side cover members are connected by a curved top wall such that a single cover unit is provided for covering the first and second channels and extending across the first end wall.

In another aspect, the connection body is provided with a cross sectional shape the same as that of the cover unit such that a join having a consistent cross section throughout is created.

In another aspect, the connection body is provided with a ball joint therein, such that the angle between the first ends of the connection members can be adjusted relative to the second ends of the connection members.

In another aspect, the connection body is provided with third end portions extending in a direction perpendicular to both the first and second end portions, the third end portions being provided to connect to a third elongate member.

### BRIEF DESCRIPTION OF THE DRAWINGS

The objects, features and advantages of the present invention will be apparent from the following detailed descriptions of the various aspects of the invention. In conjunction with reference to the following drawings, where:

FIG. 1a is a top, perspective-view illustration of a frame assembly for holding louvres according to principles of the present invention;

FIG. 1b is an exploded-view illustration of the frame assembly of FIG. 1a according to principles of the present invention;

FIG. 2 is an end-view illustration, of one of the elongate members of the frame assembly of FIG. 1 according to principles of the present invention;

FIG. 3 is a top, perspective-view illustration of a segment of the elongate member according to principles of the present invention;

FIG. 4a is a top-view illustration of one of the connection members of the frame connection according to principles of the present invention;

FIG. 4b is a side-view of the connection member of FIG. 4a according to principles of the present invention;

FIG. 4c is a top, perspective-view illustration of the connection member of FIG. 4a according to principles of the present invention;

FIG. 4d is a bottom, perspective-view illustration of the connection member of FIG. 4a according to principles of the present invention;

FIG. 5 illustrates an enlarged view of the adjacent ends of the elongate members of FIG. 1b according to principles of the present invention;

FIG. 6a is a top-view illustration of an end support for use with the frame assembly of FIG. 1a according to principles of the present invention;

FIG. 6b is a side-view illustration of the end support of FIG. 6a according to principles of the present invention;

FIG. 6c is a front-view illustration of the end support of FIG. 6a according to principles of the present invention;

FIG. 6d is a top, perspective-view illustration of the end support of FIG. 6a according to principles of the present invention;

FIG. 6e is a bottom, perspective-view illustration of the end sill port of FIG. 6a according to principles of the present invention;

FIG. 7a is a top-view illustration of an end support cover plate for use with the end support. of FIGS. 6a-6e according to principles of the present invention;

FIG. 7b is a side-view illustration of the end support cover plate of FIG. 7a according to principles of the present invention;

FIG. 7c is a top, perspective-view illustration of the end support cover plate of FIG. 7a according to principles of the present invention;

FIG. 7d is a bottom, perspective-view illustration of the end support cover plate of FIG. 7a according to principles of the present invention;

FIG. 8a is a top, perspective-view of a fence panel incorporating the frame connection according to principles of the present invention;

FIG. 8b is an exploded-view illustration of the fence panel of FIG. 8a showing connection of the cud supports according to principle's of the present invention;

FIG. 9a is a top, perspective-view illustration of a second embodiment of a frame assembly incorporating the frame connection according to principles of the present invention;

FIG. 9b is an exploded-view illustration of the frame assembly of FIG. 9a according to principles of the present invention;

FIG. 10a is a top-view illustration of a connection member of the frame connection of FIG. 9 according to principles of the present invention;

FIG. 10b is a side-view illustration of the connection member of FIG. 10a according to principles of the present invention;

FIG. 10c is a front-view illustration of the connection member of FIG. 10a according to principles of the present invention;

FIG. 10d is a top, perspective-view illustration of the connection member of FIG. 10a according to principles of the present invention;

FIG. 10e is a bottom, perspective-view illustration of the connection member of FIG. 10a according to principles of the present invention;

FIG. 11 is an illustration of an enlarged view of the adjacent ends of the elongate members of FIG. 9b according to principles of the present invention;

FIG. 12a is a front-view illustration of the frame assembly of FIG. 9a according to principles of the present invention;

FIG. 12b is a side-view illustration of the frame assembly of FIG. 9a according to principles of the present invention;

FIG. 12c is a cross-sectional view of the frame assembly through the line C-C according to principles of the present invention;

FIG. 12d is an illustration of an enlarged view of Detail D of FIG. 12c according to principles of the present invention;

FIG. 13a is a top, perspective-view illustration of a third embodiment of a frame connection according to principles of the present invention;

FIG. 13b is an exploded-view illustration of the frame connection of FIG. 13a according to principles of the present invention;

FIG. 13c is a top, perspective-view illustration of the flame connection of FIG. 13a with side cover members attached according to principles of the present invention;

FIG. 14a is a top, perspective-view illustration of a fourth embodiment of a frame connection according to principles of the present invention;

FIG. 14b is a side-view illustration of the frame connection of FIG. 14a according to principles of the present invention;

FIG. 14e is a top, perspective-view illustration of the frame connection of FIG. 14a with side cover members attached according to principles of the present invention;

FIG. 14d is an exploded-view illustration of the frame connection of FIG. 14a according to principles of the present invention;

FIG. 15a is a top, perspective-view of a fence assembly connected by a fourth embodiment of a frame connection according to principles of the present invention;

FIG. 15b is an enlarged, exploded-view illustration of Detail A of FIG. 15a according to principles of the present invention;

FIG. 16a is a top, perspective-view illustration of a fence assembly connected by a fifth embodiment of a frame connection according to principles of the present invention;

FIG. 16b is an enlarged, exploded-view illustration of Detail B of FIG. 16a according to principles of the present invention;

FIG. 17a is a top, perspective-view illustration of a fence assembly connected by a sixth embodiment of a frame connection according to principles of the present invention; and

FIG. 17b is an enlarged, exploded-view illustration of Detail C of FIG. 17a according to principles of the present invention.

### DETAILED DESCRIPTION

The present invention relates to a frame connection and, more particularly, to a frame connection for connecting members of a frame without visible, fixings. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein h reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

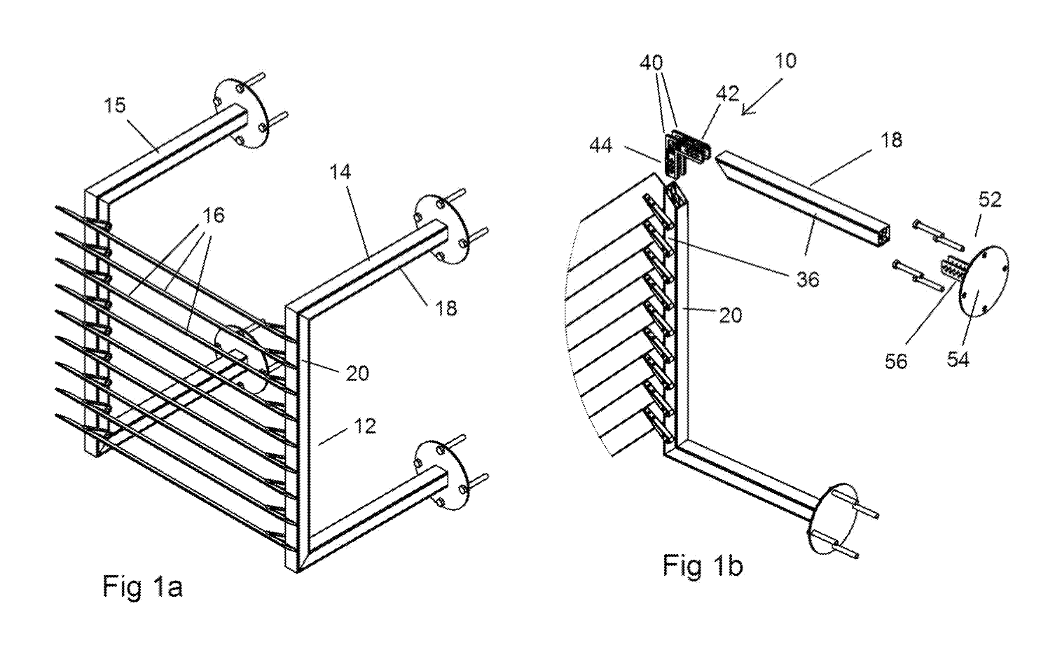

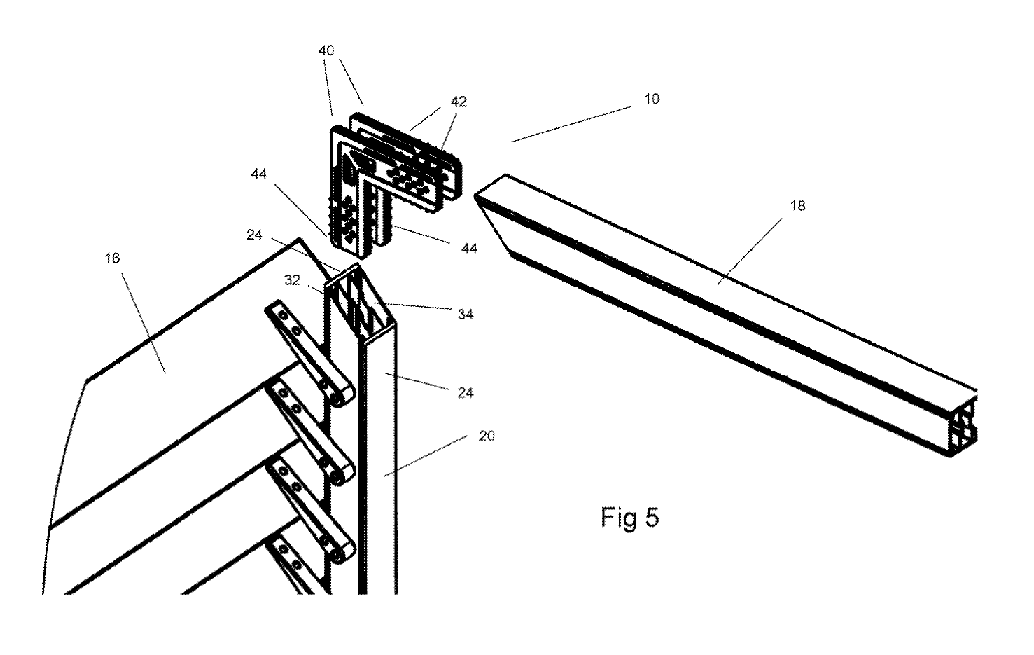

Referring, to the figures, there is shown a frame connection 10 for connecting elongate members of a frame assembly 12. In the embodiment of FIGS. 1 to 5, the frame assembly 12 comprises as first frame portion 14 and a second frame portion 15. Each of the first and second frame portions 14 and 15 comprise a plurality of elongate members mounted to a vertical surface, such as a wall around a window. A plurality of louvre blades 16 are secured between the first frame portion 14 and the second frame portion 15.

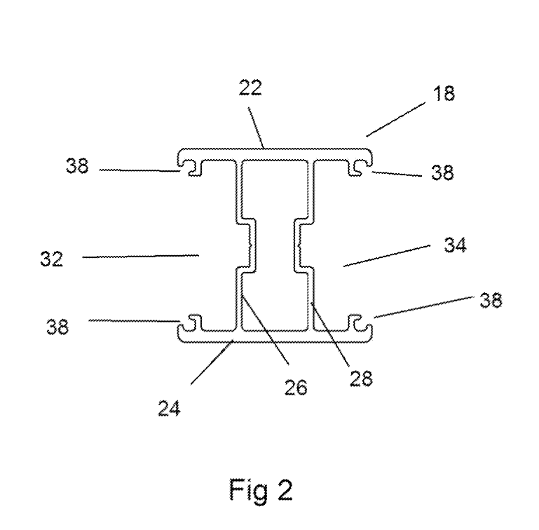

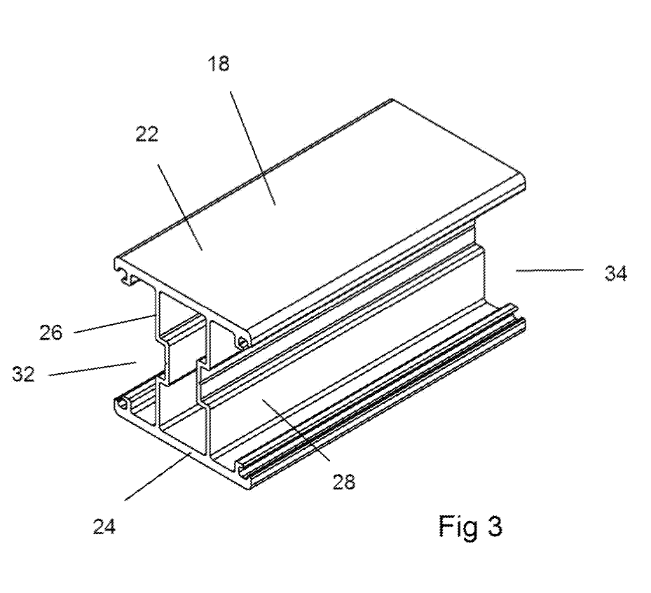

In the embodiment shown, each of the elongate members comprises an extrusion having a cross sectional shape as shown in FIGS. 2 and 3. The invention comprises a frame connection 10 for connecting a pair of adjacent elongate members and will be described with reference to a first elongate member 18 and a second elongate member 20, as shown in FIG. 1b.

With reference to FIGS. 2 and 3, each of the first and second elongate members 18 and 20 is formed by parallel first and second end walls 22 and 24. The end walls 22 and 24 are interconnected by first and second inner walls 26 and 28. The first and second inner walls 26 and 28 are each offset from the ends of the first and second end walls 22 and 24 such that longitudinal channels are defined. A first channel 32 is defined adjacent a first side of the elongate member between the first inner wall 26 and the first ends of the first and second end walls 22 and 24. A second channel 34 is defined adjacent a second side of the elongate member between the second inner wall 28 and the second ends of the first and second end walls 22 and 24.

In transverse cross section, the first and second elongate members 18 and 20 are therefore, generally of an H-shape. The first and second channels 32 and 34 are closed off at the first and second sides of the elongate members by side cover members 36. Each of the first and second side walls 22 and 24 is provided with longitudinal slots 38 along the edges thereof such that these slots 38 can receive complementary ribs provided on the side cover members 36. The side cover members 36 can be press fit across the channels 32 and 34 to provide a finished appearance to the first and second elongate members 18 and 20.

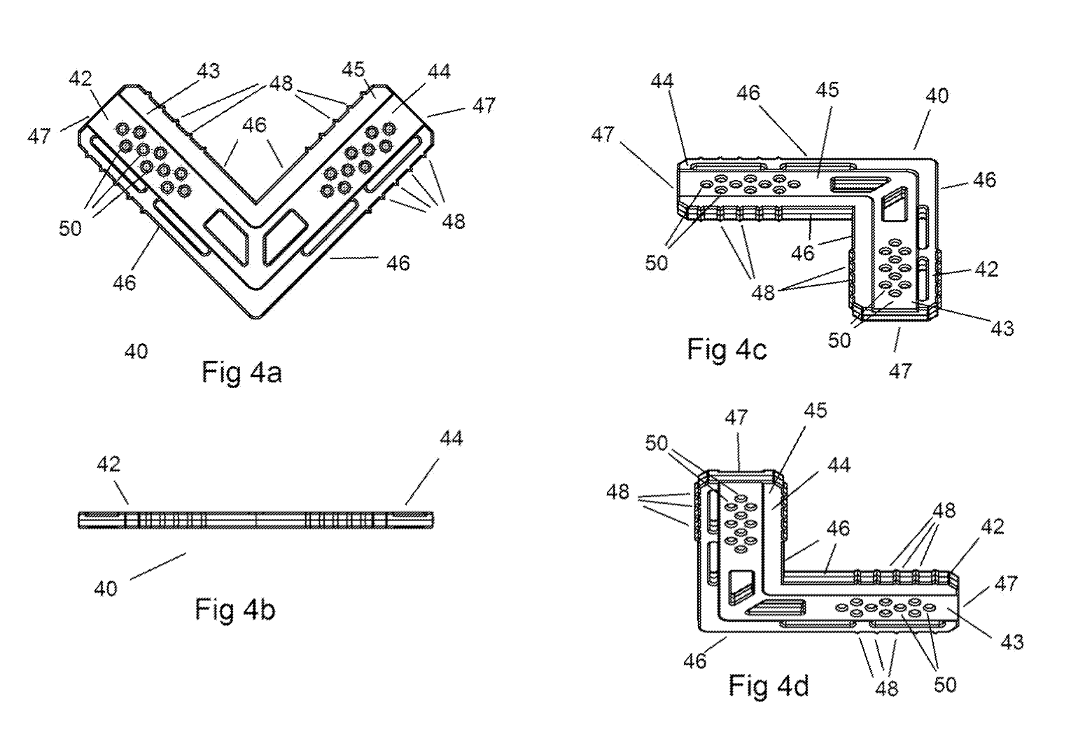

The first and second elongate members 18 and 20 are secured together at first ends thereof by a pair of connection members 40, as shown in FIG. 4. Adjacent ends of the first and second elongate members 18 and 20 are angled such that the end of the first elongate member 18 meets the end of the second elongate member 20 in a mitred joint. In the embodiment shown in which the connection is perpendicular, the ends of the each of the elongate members 18 and 20 are cut at 45 degrees.

The connection member 40 comprises a. first end portion 42 that is to be received in the first channel 32 or the second channel 34 of the first elongate member 18 and a second end portion 44 that is to be received in the corresponding channel 32 or 34 of the second elongate member 20.

The first end portion 42 comprises a first planar member 43 having opposed parallel sides 46 and a distal end 47. The second end portion 44 comprises a second planar member 45 having also parallel sides 46 and a distal end 47. The first and second planar members 43 and 45 are oriented in the same plane and opposed sides 46 of the first planar member 43 are perpendicular to opposed sides 46 of the second planar member 45. That is, the connection member 40 forms generally an L-shaped plate.

The first and second channels 32 and 34 of the elongate members 18 and 20 are of complementary shape to the first and second end portions 42 and 44 of the connection members 40. That is, in cross section the length of the channels 32 and 34 between the first and second end walls 22 and 24 is relatively large compared to the width between the inner wall 26 or 28 and the side cover member 36.

In use, the first end portion 42 of a first connection member 40 is inserted into the first channel 32 of the first elongate member 18 and the Second end portion 44 of the first connection member 40 is inserted into the first channel 32 of the second elongate member 20. The first end portion 42 of a second connection member 40 is inserted into the second channel 34 of the first elongate member 18 and the second end portion 44 of the second connection member 40 is inserted into the second channel 34 of the second elongate member 20.

The opposed sides 46 of each of the first and second end portions 42 and 44 of the connection members 40 are provided with a plurality of protrusions 48 thereon, The protrusions 48 engage with the inner sides of the end walls 22 and 24 such that the connection members 40 must be press fit into the channels 32 and 34. The connection members 40 may for example, be constructed of a plastic based material with the elongate members 18 and 20 being metal extrusions. The protrusions 48 will, therefore, deform as they engage with the inner sides of the end walls 22 and 24. In the embodiment shown, the protrusions 48 each comprise a triangular shaped protrusion.

The connection members 40 are also provided with a plurality of holes 50 in both the first and second end portions 42 and 44 thereof. Once the connection members 40 are pressed into the channels 32 and 34, a suitable fastener, a non-limiting example of which includes a threaded fastener, may be inserted through one or more of the holes 50 into the inner wall 26 or 28. By drilling into the inner wall 26 or 28, the threaded fastener can further securely connect the connection member 40 to the elongate member 18 or 20 before the side cover member 36 is pressed into place.

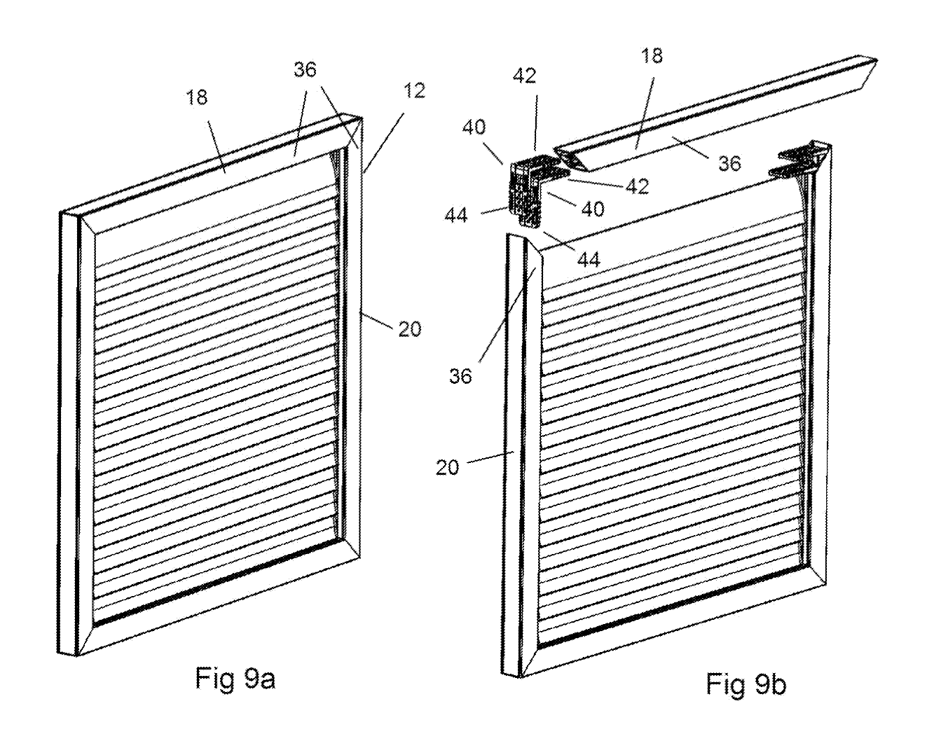

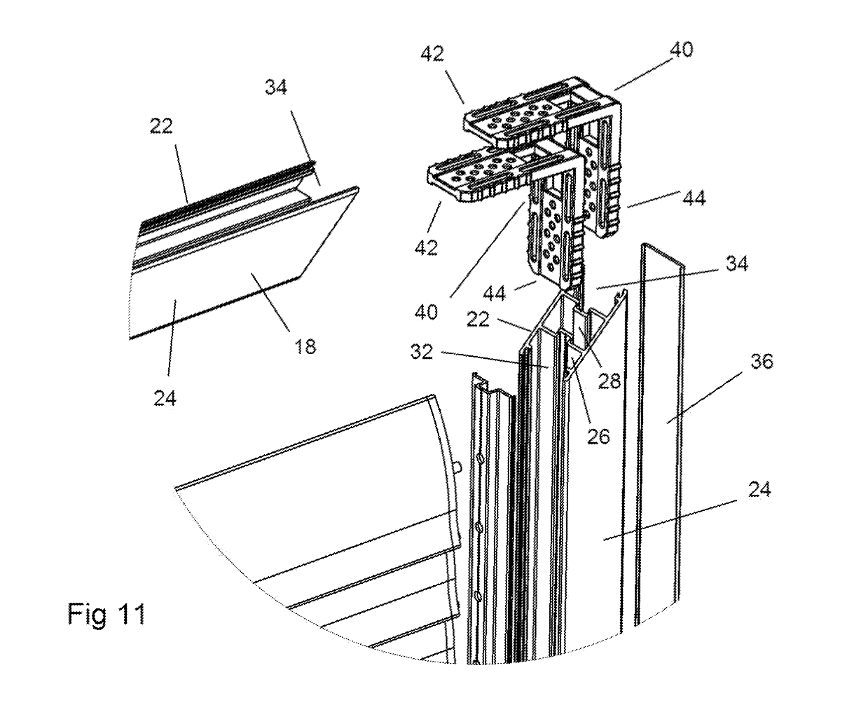

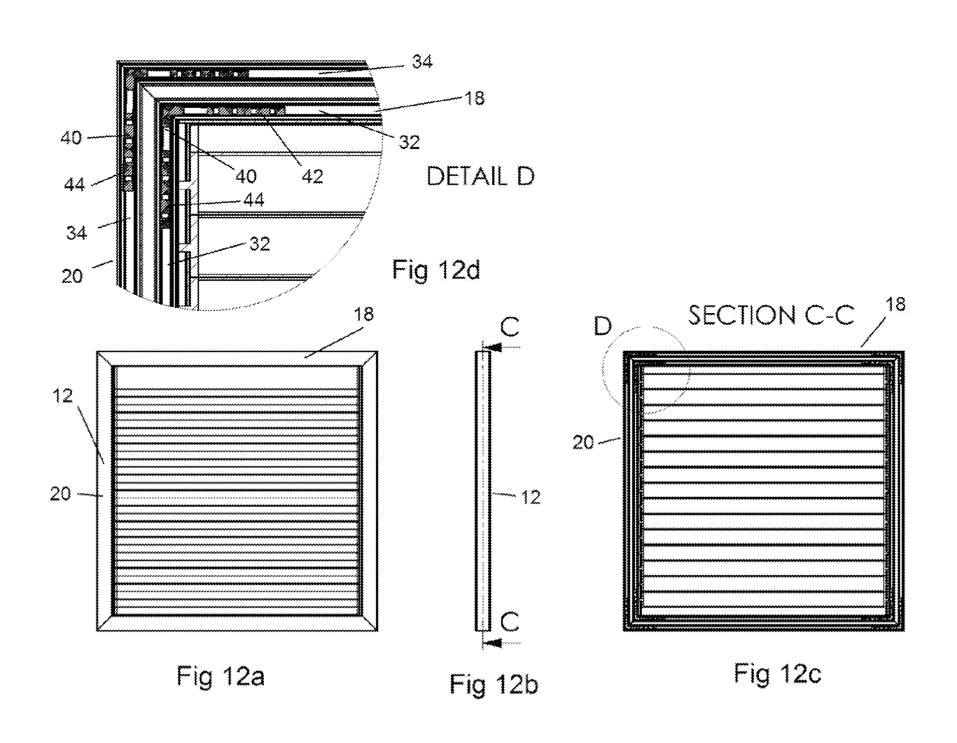

FIGS. 9 to 12 show a second embodiment of a frame connection 10 in accordance with the present invention and like reference numerals are used to denote like parts. In the embodiment of FIGS. 9 to 12, the first and second elongate members 18 and 20 have the same cross-sectional shape as the first embodiment, however the connection is rotated by 90 degrees, in the first embodiment, the mitred joint between the first and second elongate members 18 and 20 is cut such that the first and second channels 32 and 34 are each on an opposite side of the plane in which the connected elongate members 18 and 20 lie. That is, if the first and second elongate member 18 and 20 were formed into a frame as shown in FIG. 9, the channels 12 and 34 would he on opposite sides of the formed frame assembly. In the embodiment of FIGS. 9 to 12, however, the first channel 32 is on the inside of the frame assembly 12, and the second channel 34 is on the outside of the frame assembly 12.

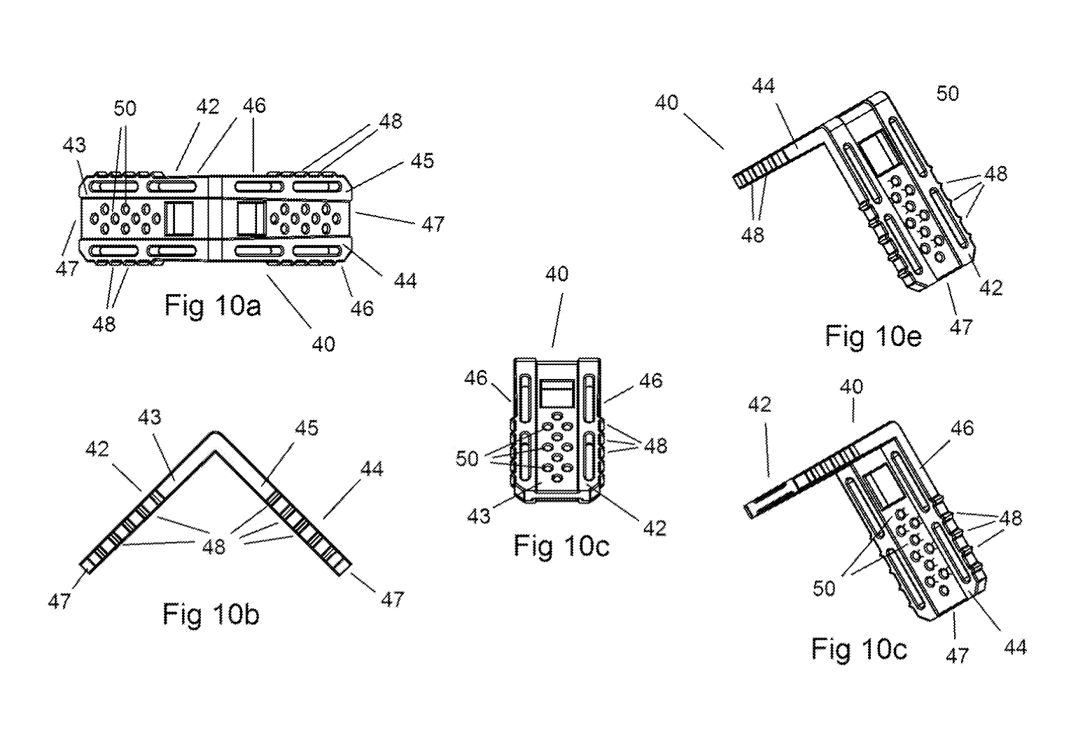

The connection members 40 of the second embodiment (as shown in FIG. 10) are, therefore, modified in shape. While the first and second portions 42 and 44 are still connected perpendicularly to form an L-shape, the first planar member 43 of the connection member 40 is oriented in a plane perpendicular to that of the second planar member 45. Other features of the connection members 40 remain the same, and the connection members 40 are used to connect together the first and second elongate members 18 and 20 in the same manner as described above.

Also provided are end supports 52 for connecting an elongate member of the frame assembly 12 to a supporting surface, such as a wall or the ground. The end support 52 comprises a base plate 54 and a pair of planar members 56. Each of the planar members 56 are of similar constructions to the first and second planar members 43 and 45 of the connection members 40 in that each include opposed parallel sides 46 having protrusions 48 and a distal end 47. The planar members 56, however, each extend parallel to each other from the base plate 56. The planar members 56 are arranged to be received in the first and second channels 32 and 34 of an elongate member that is to be connected to the supporting surface. The base plate 54 is then connected to the supporting surface by suitable means, such as threaded fasteners.

An end support over plate 58 is also provided to fit over the base plate 56.

The end support cover plate 58 includes an aperture 60 through which the elongate member is received.

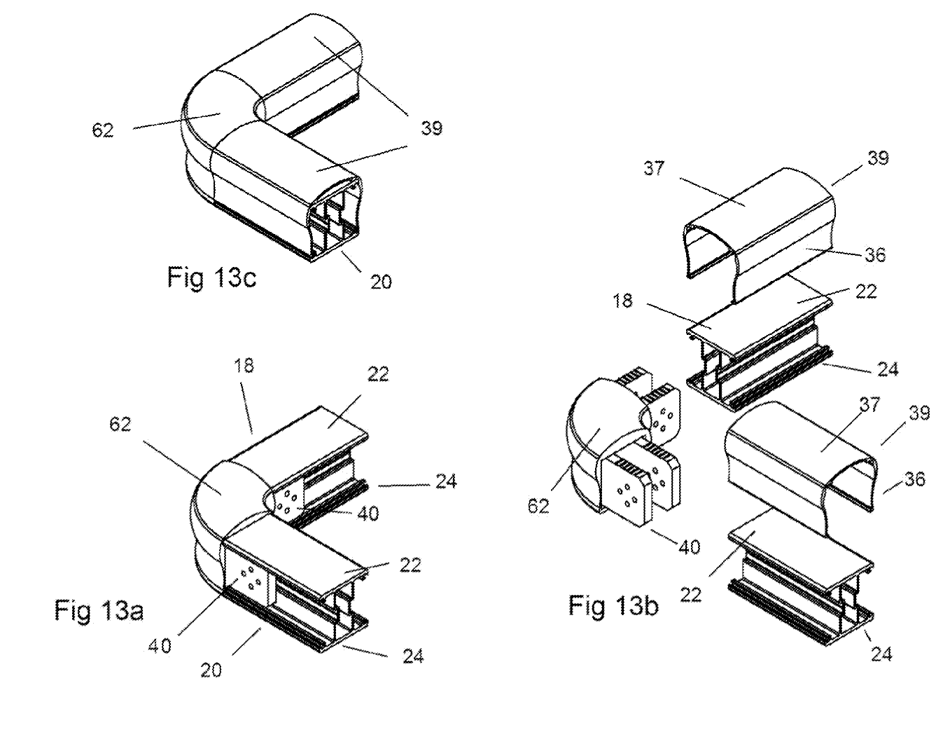

FIG. 13 illustrates a third embodiment of a frame connection 10 in accordance with the present invention. The embodiment of FIG. 13 is similar to that of the embodiment of FIG. 9 and like reference numerals are used to denote like parts.

In the embodiment of FIG. 13, the first and second connection members 40 are fixed together. A connection body 62 is provided such that the connection body 62 connects a portion of the first connection member 40 between the first and second ends thereof to the second connection member 40 between the first and second ends thereof.

The side cover members 36 in this embodiment are connected by a curved top wall 37 such that a single cover unit 39 is provided for covering the first and second channels 32 and 34 and extending across the first end wall 22, The connection body 62 is provided with a cross sectional shape the same as that of the cover unit 39 such that a join having a consistent cross section throughout is created. The first and second elongate members 18 and 20 of this type may be used as part of a handrail structure.

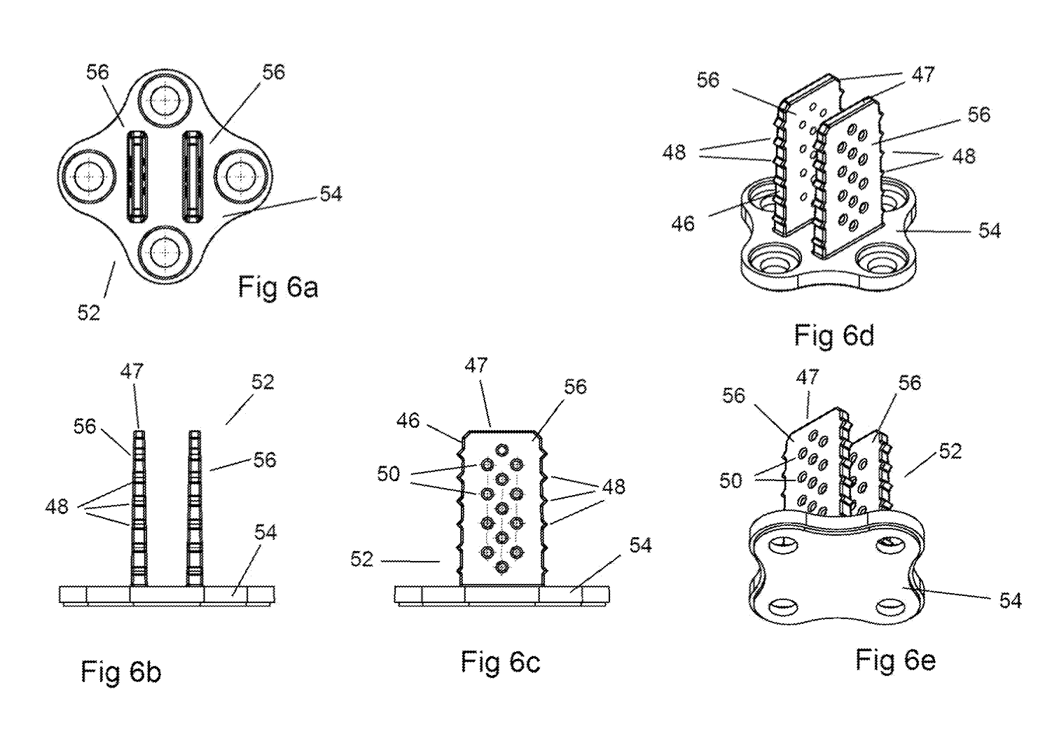

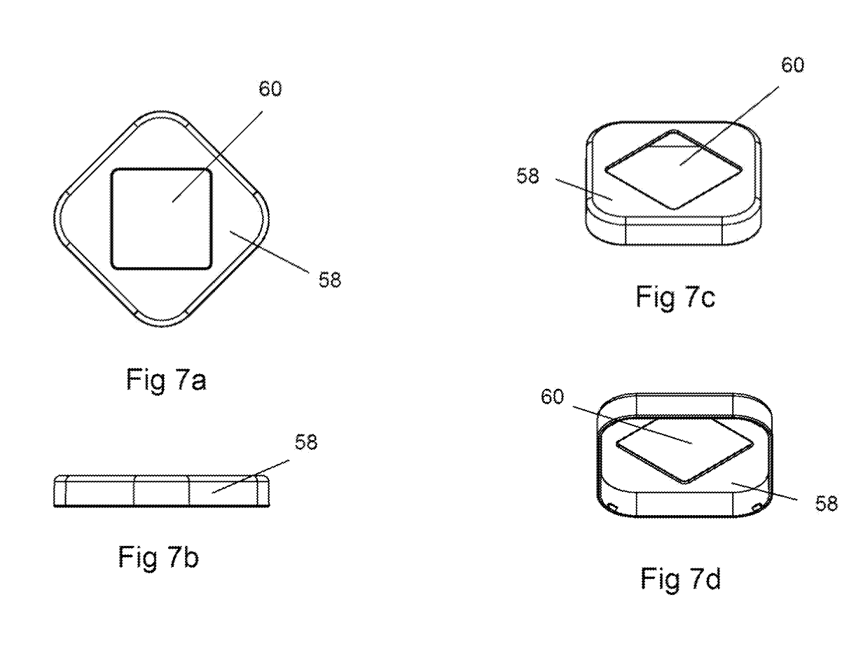

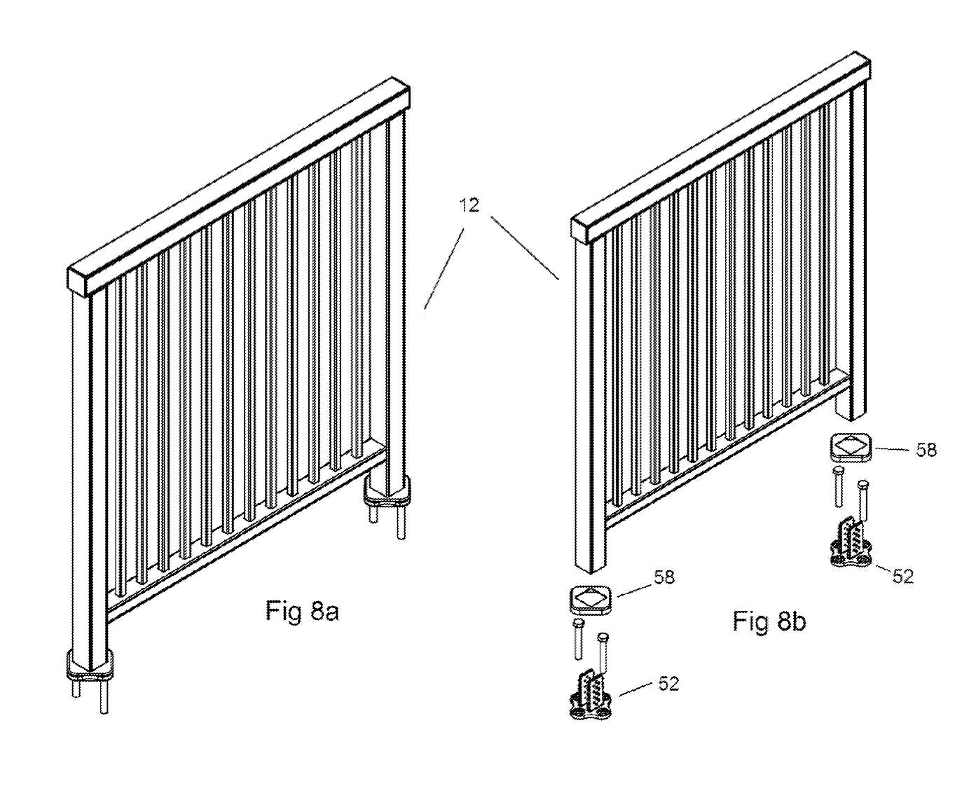

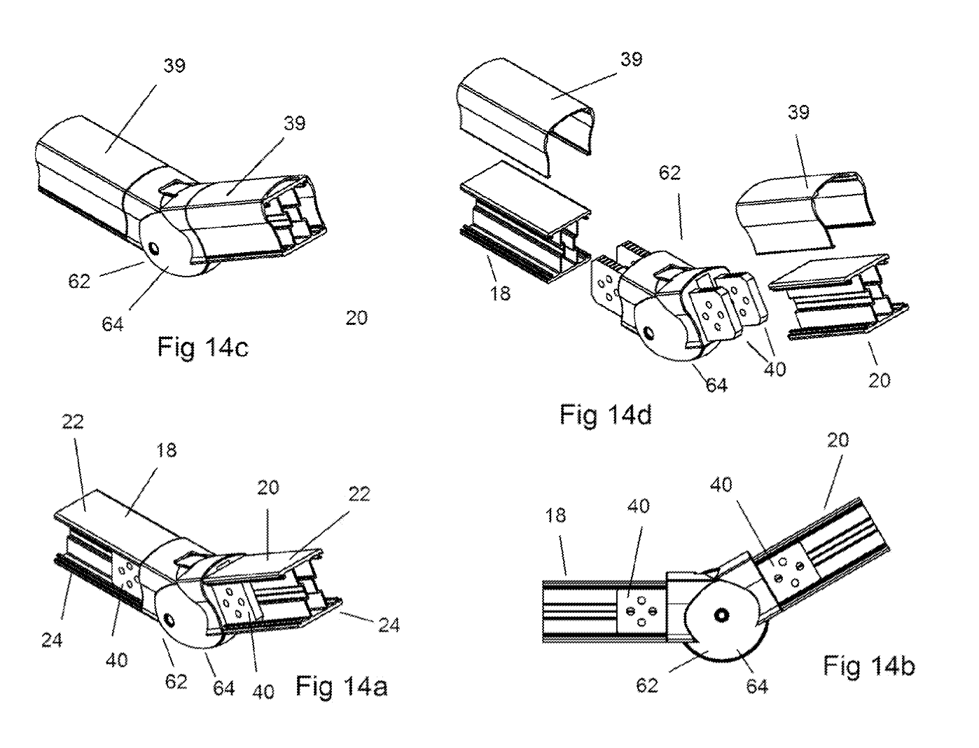

FIG. 14 shows a fourth embodiment of a frame connection in accordance with the present invention. The fourth embodiment is similar to the third embodiment in that a connection body 62 is provided to connect the first arid second connection members 40. The connection members 40 however are oriented in the same configuration as the embodiment of FIGS. 1 to 8.

The connection body 62 is provided with a ball joint 64 therein such that the angle between the first ends of the connection members 40 can be adjusted relative to the second ends of the connection members 40. The first and second elongate members 18 and 20 of this embodiment may also be used in a handrail structure in which the angle between the connected rails can be adjusted. Such an arrangement would be suitable for example when the handrail extends upwardly adjacent a staircase.

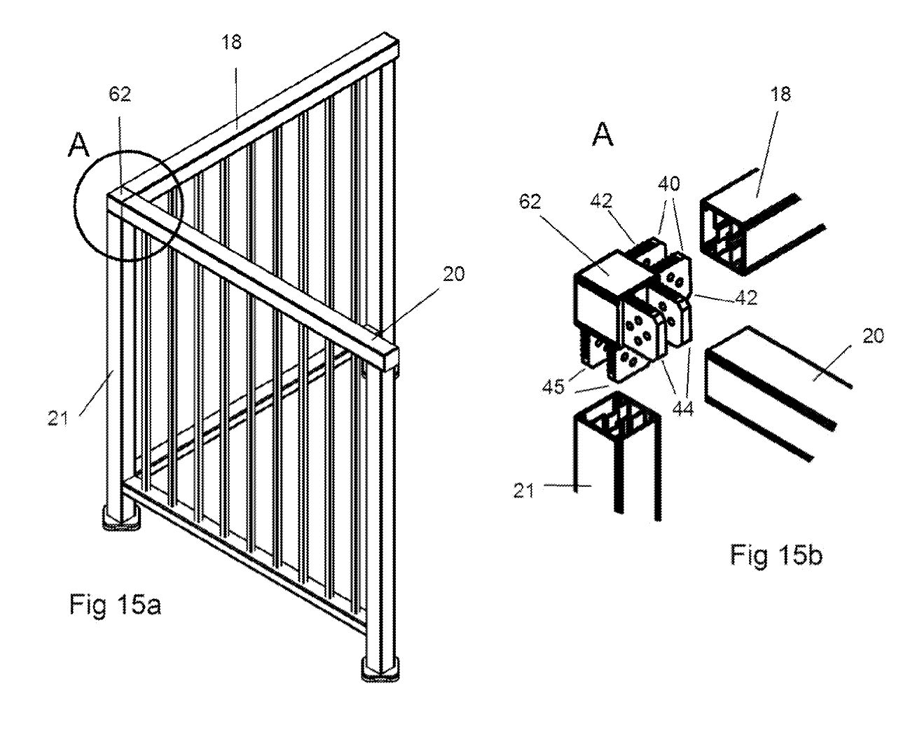

FIG. 15 shows a fourth embodiment of a frame connection 10 in accordance with the present invention. The embodiment of FIG. 15 is similar to that of the embodiment of FIG. 13 and like reference numerals are used to denote like parts.

In the embodiment of FIG. 15, the first and second connection members 40 are fixed together and a connection body 62 is provided such that the connection body 62 connects a portion of the first connection member 40 between the first and second ends 42 and 43 thereof to the second connection member 40 between the first and second ends 42 and 43 thereof.

The connection body 62, however, is provided with third end portions 45 extending in a direction perpendicular to both the first and second end portions 42 and 44. The first and second end portions 42 and 43 are provided, to connect the first elongate member 18 to the second elongate member 20 in the same manner as the second embodiment. The third end portions 45 are provided to connect to a third elongate member 21. The orientation of the third end portions 45 are such that the connection provided by the first and third end portions 42 and 45 is the same as that of the first embodiment. The first, second and third elongate members 18, 20 and 21 are thereby connected all at right angles to create a corner join of the fencing assembly as can be seen in FIG. 15a.

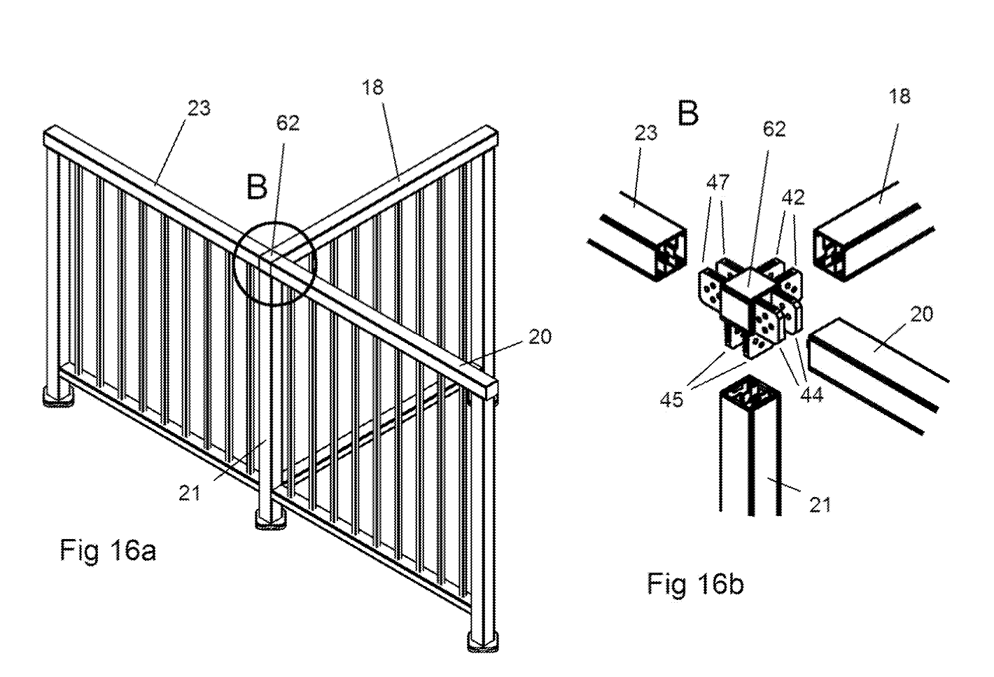

FIG. 16 shows a fifth embodiment of a frame connection 10 in accordance with the present invention. The embodiment of FIG. 16 is similar to that of the embodiment of FIG. 15 and like reference numerals are used to denote like parts.

In the embodiment of FIG. 16, the connection body 62 is provided with fourth end portions 45 extending parallel to the second end portions 44 but in an opposite direction, The fourth end portions 45 are provided to connect to a fourth elongate member 23. The orientation of the fourth end portions 45 are such that the connection provided by the first and fourth end portions 42 and 47 is the same as that of the second embodiment. The fourth elongate member 23 extends in a direction away from the second elongate member 20 such that a T-join of the fencing assembly is provided as can be seen in FIG. 16a.

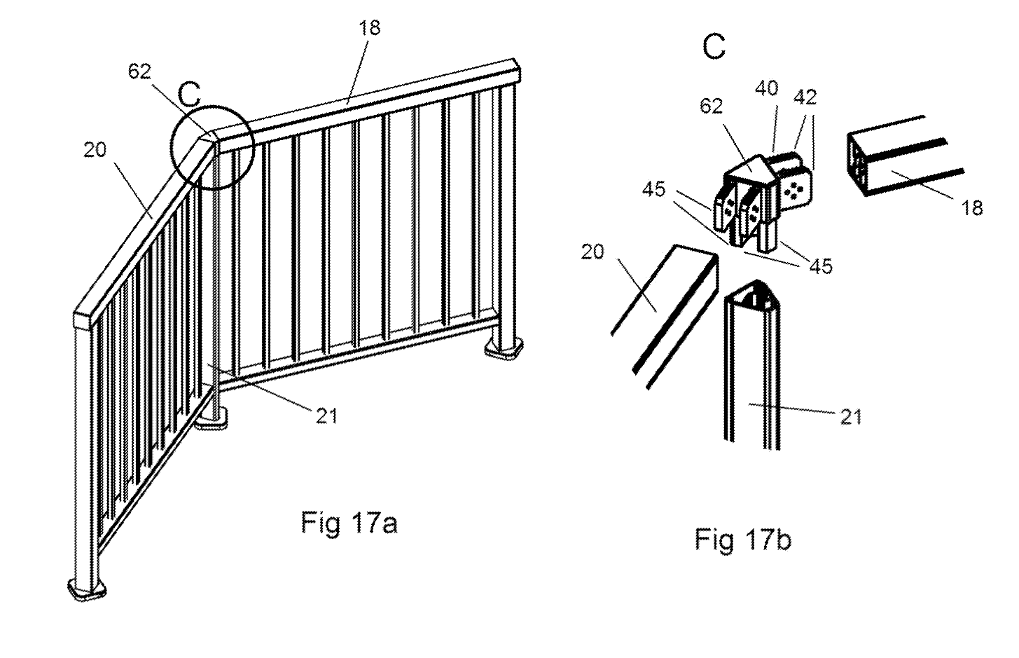

FIG. 17 shows a sixth embodiment of a frame connection 10. The embodiment of the frame connection 10 of FIG. 17 is similar to that of FIG. 15. In this embodiment, however, the first and second end portions 42 and 45 are at an obtuse angle to each other. The connection, therefore, provides a bend connection for the fence assembly, as shown in FIG. 17a.

It will be readily apparent to persons skilled in the relevant arts that various modifications and improvements may be made to the foregoing embodiments, in addition to those already described, without departing from the basic inventive concepts of the present invention.

What is claimed is:

1. A frame connection comprising:
a first elongate member having first and second channels, the first channel being in a first longitudinal side of the first elongate member and the second channel being in an opposed second longitudinal side of the first elongate member;
a second elongate member having first and second channels, the first channel being in a first longitudinal side of the second elongate member and the second channel being in an opposed second longitudinal side of the second elongate member;
a first connection member having a first end portion comprising a first planar member and a second end portion comprising a second planar member, each of the first and second end portions including one or more holes therein;
a second connection member having a first end portion comprising a first planar member and a second end portion comprising a second planar member, each of the first and second end portions including one or more holes therein; and side cover members;
wherein the first end portions of the first and second connection members are received in the first and second channels, respectively, of the first elongate member, the second end portions of the first and second connection members are received in the first and second channels, respectively, of the second elongate member, fasteners are received through the holes to secure the first and second connection members to the first and second elongate members, and the side cover members are then secured across the first and second channels of the first and second elongate members.

2. The frame connection as set forth in claim 1, wherein the first and second end portions of the first and second connection members each comprise opposed parallel sides and a distal end.

3. The frame connection as set forth in claim 2, wherein the opposed parallel sides of each of the first and second end portions are provided with a plurality of protrusions thereon to engage with the inner sides of the channels such that the connection members are press fit into the channels.

4. The frame connection as set forth in claim 3, wherein the protrusions are constructed of a material to be deformed as the protrusions engage with inner sides of the channels.

5. The frame connection as set forth in claim 4, wherein the protrusions each comprise a triangular shaped protrusion.

6. The frame connection as set forth in Claim 1, wherein the first and second elongate members are formed by parallel first and second end walls interconnected by first and second inner walls, such that the first channel is defined adjacent a first side of the elongate member between the first inner wall and the first ends of the first and second end walls and the second channel is defined adjacent a second side of the elongate member between the second inner wall and the second ends of the first and second end walls.

7. The frame connection as set forth in claim 6, wherein the first and second channels of the elongate members are of complementary shape to the first and second end portions of the connection members such that in cross section the length of the channels between the first and second end walls is relatively large compared to the width.

8. The frame connection as set forth in claim 7, wherein each of the first and second side walls is provided with longitudinal slots along the edges thereof such that the slots can receive complementary ribs provided on the side cover members to allow the side cover members to be press fit across the channels.

9. The frame connection as set forth in claim 2, wherein the first and second planar members are oriented in the same plane and opposed parallel sides of the first planar member are perpendicular to opposed parallel sides of the second planar member.

10. The frame connection as set forth in claim 2, wherein the first planar member of each connection member is oriented in a plane perpendicular to that of the second planar member.

11. The frame connection as set forth in claim 1, wherein a connection body is provided such that the connection body connects a portion of the first connection member between the first and second ends thereof to the second connection member between the first and second ends thereof.

12. The frame connection as set forth in claim 11, wherein the side cover members are connected by a curved top wall such that a single cover unit is provided for covering the first and second channels and extending across the first end wall.

13. frame connection as set forth in claim 12, wherein the connection body is provided with a cross sectional shape the same as that of the cover unit such that a join having a consistent cross section throughout is created.

14. The frame connection as set forth in claim 11, wherein the connection body is provided with a ball joint therein, such that the angle between the first ends of the connection members can be adjusted relative to the second ends of the connection members.

15. The frame connection as set forth in Claim 11, wherein the connection body is provided with third end portions extending in a direction perpendicular to both the first and second end portions, the third end portions being provided to connect to a third elongate member.

16. The frame connection as set forth in claim 5, wherein the first and second elongate members are formed by parallel first and second end walls interconnected by first and second inner walls such that the first channel is defined adjacent a first side of the elongate member between the first inner wall and the first ends of the first and second end walls and the second channel is defined adjacent a second side of the elongate member between the second inner wall and the second ends of the first and second end walls.

17. The frame connection as set forth in claim 8, wherein the first and second planar members are oriented in the same plane and opposed parallel sides of the first planar member are perpendicular to opposed parallel sides of the second planar member.

18. The frame connection as set forth in claim 8, wherein the first planar member of each connection member is oriented in a plane perpendicular to that of the second planar member.

19. The frame connection as set forth in claim 8, wherein a connection body is provided such that the connection body connects a portion of the first connection member between the first and second ends thereof to the second connection member between the first and second ends thereof.
